(19) United States
(12) Patent Application Publication
(10) Pub. No.: US 2013/0153424 A1
(43) Pub. Date: Jun. 20, 2013

(54) MICROCHIP

(71) Applicant: Sony Corporation, Tokyo (JP)

(72) Inventors: Masahiro Matsumoto, Kanagawa (JP); Michihiro Ohnishi, Kanagawa (JP); Yoshiaki Kato, Kanagawa (JP); Toshio Watanabe, Kanagawa (JP)

(73) Assignee: SONY CORPORATION, Tokyo (JP)

(21) Appl. No.: 13/709,770

(22) Filed: Dec. 10, 2012

(30) Foreign Application Priority Data
Dec. 20, 2011 (JP) 2011-277831

(51) Int. Cl. G01N 27/447

(52) U.S. Cl. CPC G01N 27/44743
USPC 204/604

(57) ABSTRACT

Provided is a microchip, including independently an introduction area inside having a pressure negative to atmospheric pressure and into which a liquid is injected by puncturing, and a degassing area inside having a pressure negative to atmospheric pressure for degassing a cavity of a hollow tube that punctures the introduction area for injecting the liquid.

### CROSS REFERENCES TO RELATED APPLICATIONS

The present application claims priority to Japanese Priority Patent Application JP 2011-277831 filed in the Japan Patent Office on Dec. 20, 2011, the entire content of which is hereby incorporated by reference.

### BACKGROUND

The present disclosure relates to a microchip, more particularly to a microchip for introducing a solution into an area disposed on the microchip, and analyzing a substance contained in the solution or a reaction product of the substance.

In recent years, by applying a microfabrication technique in the semiconductor industry, microchips having wells and flow channels for performing chemical and biological analyses formed on a substrate made of silicon or glass have been developed. The microchip can analyze a small amount of samples and can be disposable (single-use), and therefore is used for the biological analysis that handles a trace amount of precious samples or many test bodies.

An example of the application is an optical detector which introduces substances into a plurality of areas provided in microchips, and optically detects the substances or their reaction products thereof An example of the optical detector is an electrophoresis apparatus that separates a plurality of substances in microchips by electrophoresis, and optically detects substances separated, a reaction apparatus (for example, a nucleic acid amplification apparatus) that proceeds reactions of a plurality of substances in wells on microchips, and optically detects substances produced, or the like.

In the analysis using the microchip, it is difficult to introduce a trance amount of a sample solution into a well or a flow channel, and the introduction of the sample solution may be inhibited by air within a well or the like and take a long time. When the sample solution is introduced, air bubbles may be generated within a well or the like to change the amount of the sample solution introduced into each well or the like, which may undesirably decrease analysis precision. When the sample is analyzed by heating, the air bubbles remained within the well or the like may swell to transfer the sample solution and to inhibit the reaction, which constitutes a factor decreasing the analysis precision and efficiency.

In order to facilitate the introduction of the sample solution into the microchip, Japanese Unexamined Patent Application Publication No. 2011-163984 discloses “a microchip including an area inside having a pressure negative to atmospheric pressure into which a solution is introduced.” In the microchip, the sample solution is injected into the area inside having a negative pressure using a needle. By suction under the negative pressure, the sample solution can be introduced in a short time easily.

### SUMMARY

As described above, the microchip in the past has problems that when the sample solution is introduced, air bubbles may be generated within a well or a flow channel to decrease the analysis precision or efficiency. Thus, it is desired to provide a microchip that can introduce the sample solution into the well or the flow channel in a short time easily without generating air bubbles.

According to an embodiment of the present application, there is provided a microchip including independently an introduction area inside having a pressure negative to atmospheric pressure into which a liquid is injected by puncturing; and a degassing area inside having a pressure negative to atmospheric pressure and where a hollow tube, which punctures the introduction area for injecting the liquid, punctures for degassing a cavity of the hollow tube.

In the microchip, the hollow tube punctures the degassing area and then the introduction area, whereby the liquid can be injected into the introduction area in a state that air in the hollow tube is removed.

In the microchip, the introduction area and the degassing area may desirably be disposed such that the hollow tube punctures and passes through the degassing area and further punctures the introduction area.

According to an embodiment of the present application, there is provided a microchip that can introduce the sample solution into the well or the flow channel in a short time easily without generating air bubbles.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic top view illustrating a configuration of a microchip 1a according to a first embodiment of the present application;

FIG. 2 is a schematic cross-sectional view illustrating a configuration of the microchip 1a;

FIGS. 3A and 3B are schematic views illustrating a method of introducing a sample solution into the microchip 1a;

FIG. 4 is a schematic view illustrating a configuration of a microchip 1b according to an alternative embodiment of the first embodiment of the present application;

FIG. 5 is a schematic view illustrating a configuration of a microchip 1c according to a second embodiment of the present application;

FIGS. 6A and 6B are schematic views illustrating a method of introducing a sample solution into the microchip 1c;

FIG. 7 is a schematic view illustrating a configuration of a microchip 1d according to a third embodiment of the present application; and

FIG. 8 is a schematic view illustrating a configuration of a microchip 1e according to a fourth embodiment of the present application.

### DETAILED DESCRIPTION

Hereinafter, embodiments of the present disclosure will be described with reference to drawings. The embodiments described below merely depict typical embodiments of the present disclosure, and the scope of the present disclosure should not be construed narrower. The embodiments will be described in the following order.
1. A microchip according to a first embodiment

(1) A configuration of a microchip 1a

(2) An introduction of a sample liquid into the microchip 1a
2. A microchip according to a second embodiment

(1) A configuration of a microchip 1c

(2) An introduction of a sample liquid into the microchip 1c
3. A microchip according to a third embodiment

(1) A configuration of a microchip 1d

(2) An introduction of a sample liquid into the microchip 1d
4. A microchip according to a fourth embodiment

(1) A configuration of a microchip 1e

(2) An introduction of a sample liquid into the microchip 1e

### 1. A Microchip According to a First Embodiment

(1) A Configuration of a Microchip 1a

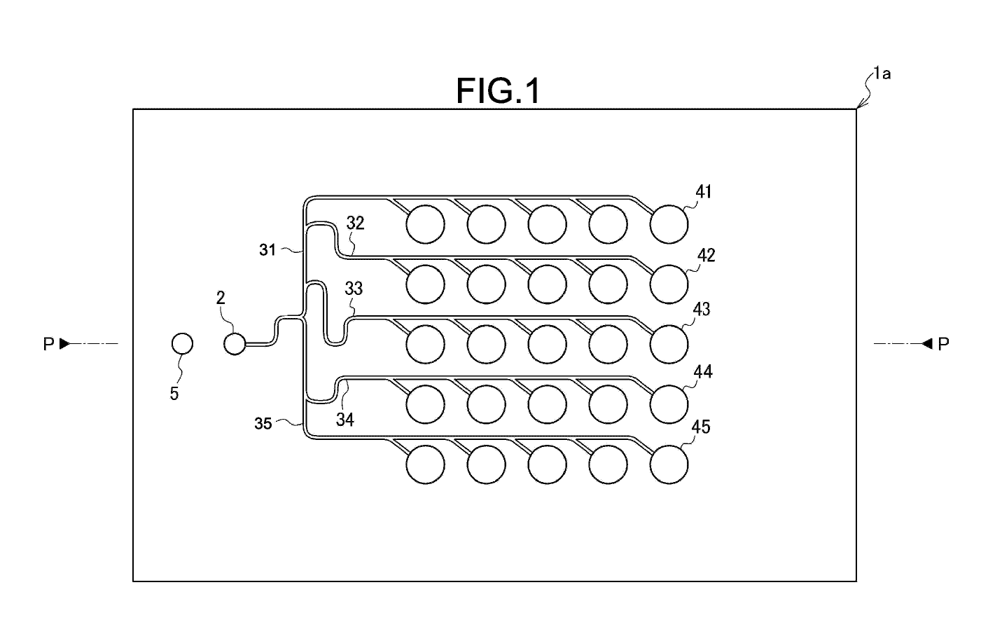

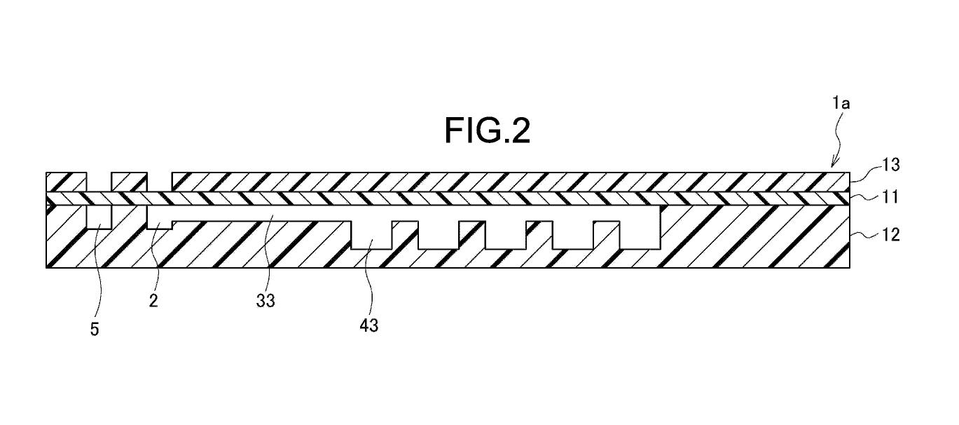

FIGS. 1 and 2 are schematic views illustrating a configuration of a microchip according to a first embodiment of the present application. FIG. 1 is a schematic top view, and FIG. 2 is a schematic cross-sectional view corresponding to a P-P cross-section in FIG. 1.

The microchip 1a includes an introduction part 2 as an area into which a sample solution (a sample liquid) is introduced (an introduction area), flow channels 31 to 35 and wells 41 to 45. The introduction part 2 is an area into which the sample liquid is injected from outside. The wells 41 to 45 are areas that become analysis sites of a substance or a reaction product of the substance contained in the sample liquid. Each of the flow channels 31 to 35 includes a main flow channel that communicates with the introduction part 2 at one end, and branched flow channels that are branched from the main flow channel and branch into the wells 41 to 45. The sample liquid injected into the introduction part 2 is sent to the wells 41 to 45. Herein, five wells to which the sample liquid is fed from the flow channel 31 are referred to the wells 41. Similarly, five wells to which the sample liquid is fed from the flow channels 32, 33, 34 and 35 are referred to the wells 42, 43, 44 and 45, respectively.

The microchip 1a includes a degassing area 5 which is an independent area separated from the introduction part 2, the flow channels 31 to 35 and the wells 41 to 45. The degassing area 5 is to degas a hollow tube (a needle) that punctures the introduction area 2 for injecting the sample liquid.

The microchip 1a is provided by bonding a substrate layer 12 having the introduction part 2, the flow channels 31 to 35, the wells 41 to 45 and the degassing area 5 with a substrate layer 11, and bonding the substrate layer 11 with a substrate layer 13. In the microchip 1a, the substrate layer 11 is bonded with substrate layer 12 at a pressure negative to atmospheric pressure so that insides of the introduction part 2, the flow channels 31 to 35, the wells 41 to 45 and the degassing area 5 have a pressure negative to atmospheric pressure (for example, 1/100 atm) and are hermetically sealed. In addition, the substrate layer 11 and the substrate layer 12 are desirably bonded under vacuum so that the insides of the introduction part 2 and others are under vacuum and hermetically sealed.

The material of the substrate layers 11, 12 and 13 can be glass and a variety of plastics. Desirably, the substrate layer 11 includes a material having elasticity, and the substrate layers 12 and 13 include a material having gas non-permeability.

As the material having elasticity, silicone-based elastomers such as polydimethylsiloxane (PDMS), as well as acrylic-based elastomers, urethane-based elastomers, fluorinated-based elastomers, styrene-based elastomers, epoxy-based elastomers, natural rubber and the like can be used. Among the materials, the substrate layer 11 including the material having elasticity and gas permeability (for example, PDMS) may be bonded with the substrate layer 12 under atmospheric pressure (normal pressure). After bonding, the substrate layers 11 and 12 are allowed to stand under a negative pressure (vacuum), such that air within the introduction part 2 is discharged through the substrate layer 11, and the insides of the introduction part 2 and others can have a pressure negative to atmosphere (vacuum).

As the material having gas non-permeability, glass, plastics, metals, ceramics and the like can be used. Examples of the plastics include PMMA (polymethyl methacrylate: acrylic resin), PC (polycarbonate), PS (polystyrene), PP (polypropylene), PE (polyethylene), PET (polyethylene terephthalate), diethylene glycol bisallyl carbonate, SAN resin (styerene-acrylonitrile copolymer), MS resin (MMA-styrene copolymer), TPX (poly(4-methylpentene-1)), polyolefin, a SiMA (siloxanyl methacrylate monomer)-MMA copolymer, a SiMA-fluorine-containing monomer copolymer, a silicone macromer (A)-HFBuMA (heptafluorobutylmethacrylate)-MMA terpolymer, disubstituted polyacetylene-based polymer and the like. Examples of the metals include aluminum, copper, stainless steel (SUS), silicon, titanium, tungsten and the like. Examples of the ceramics include alumina (Al₂O₃), aluminum nitride (AlN), silicon carbide (SiC), titanium oxide (TiO₂), zirconium oxide (ZrO₂), quartz and the like.

When the substrate layer 11 is formed of the material having elasticity such as PDMS, a “self-sealing property” which will be described later can be added to the microchip 1a. When the substrate layers 12 and 13 are formed of the material having gas non-permeability, it can prevent dissipation (leak) of the sample liquid introduced into the wells 41 to 45 that is heated, vaporized and transmitted through the substrate layer 11.

When the substances introduced into the wells 41 to 45 are optically analyzed, it is desirable to select the material having light permeability, less autofluorescence, and less optical errors because of small wavelength dispersion.

The introduction part 2, the flow channels 31 to 35, the wells 41 to 45 and the degassing area 5 can be formed on the substrate layer 12 by, for example, wet-etching or dry-etching of a glass substrate layer, or by nanoimprinting, injection molding or cutting work of a plastic substrate layer. The introduction part 2 and others may be formed on the substrate layer 11, or some of them may be formed on the substrate layer 11 and the remaining may be formed on the substrate layer 12. The substrate layers 11, 12 and 13 can be bonded by known methods including thermal fusion bonding, adhesion bonding, anodic bonding, bonding with an adhesive sheet, a plasma activation bonding and ultrasonic bonding and the like.

(2) An Introduction of a Sample Liquid into the Microchip 1a

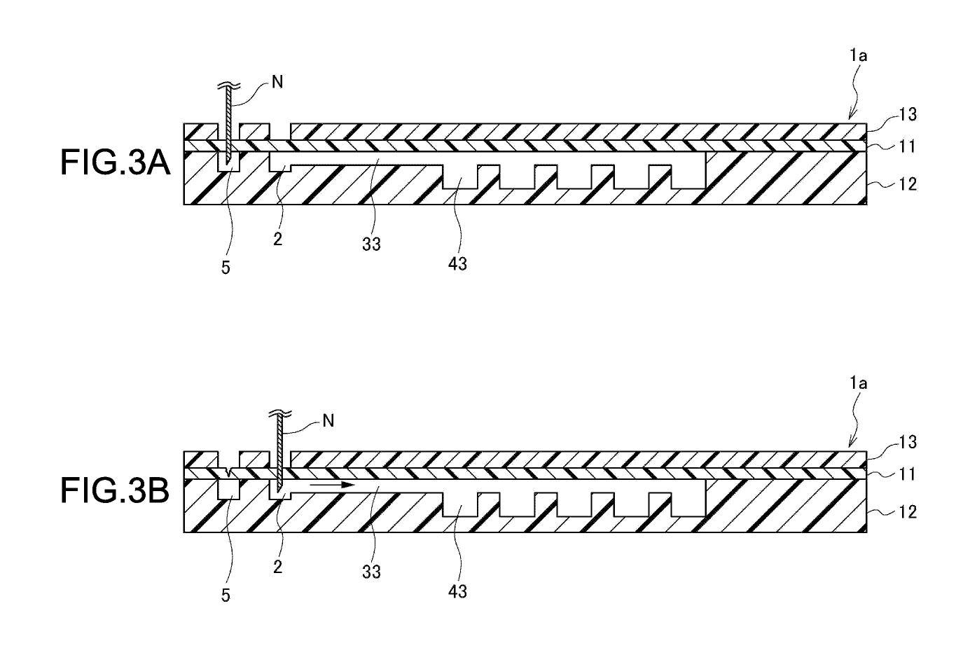

Now, referring to FIGS. 3A and 3B, the method of introducing the sample liquid into the microchip 1a will be described. FIGS. 3A and 3B are cross-sectional views of the microchip 1a and are corresponded to a P-P cross-section in FIG. 1.

[An Injection Procedure]

As shown in FIG. 3B, the sample solution is introduced into the microchip 1a by puncturing and injecting the sample liquid into the introduction part 2 using the hollow tube (hereinafter referred to as a “needle N”). An opening for inserting and passing through the needle N is disposed at the position corresponding to the introduction part 2 of the substrate layer 13. The needle N punctures from the opening to the surface of the substrate layer 11. The needle N continues to puncture until a tip thereof is penetrated through the substrate layer 11 and reaches the introduction part 2.

In the microchip 1a, as the insides of the introduction part 2, the flow channels 31 to 35 and the wells 41 to 45 have a pressure negative to atmospheric pressure, once the tip of the needle N reaches the introduction part 2, the sample liquid in a sample liquid holder connected to the other end of the needle N is sucked by the negative pressure and is introduced into the introduction part 2 through a cavity of the needle N. The sample liquid introduced into the introduction part 2 is further sent to the flow channels 31 to 35 and the wells 41 to 45 by the negative pressure.

At this point, when air exists within the cavity of the needle N punctured to the introduction part 2, the air may be sucked by the introduction part 2 and may generate air bubbles within the flow channels 31 to 35 or the wells 41 to 45. In order to prevent this, in the microchip 1a, upon the introduction of the sample liquid, a degassing procedure of puncturing the degassing area 5 by the needle N to remove air within the cavity is performed before the injection procedure of puncturing the introduction part 2 by the needle N to inject the sample liquid is performed (see FIG. 3A).

[A Degassing Procedure]

In other words, before the sample liquid is injected, the needle N is firstly inserted and passed through the opening disposed at the position corresponding to the degassing area 5 of the substrate layer 13, and punctures the surface of the substrate layer 11 such that the tip of the needle N is penetrated through the substrate layer 11 to reach the degassing area 5. As the inside of the degassing area 5 has a pressure negative to atmospheric pressure, once the tip of the needle N reaches the degassing area 5, air within the cavity is sucked by the negative pressure and is discharged from the tip of the needle N together with the sample liquid. As a result, the cavity of the needle N is degassed.

In order to fully suck air within the cavity of the needle N, it is desirable that a volume of the degassing area 5 be greater than that of the cavity of the needle N.

After the cavity is degassed, the needle N is drawn out from the degassing area 5. When the substrate layer 11 is formed of the material having elasticity such as PDMS, the punctured portion can be sealed spontaneously by resilience generated from elastic deformation of the substrate layer 11, after the needle N is drawn out. In the present application, the spontaneous sealing of the needle punctured potion by elastic deformation of the substrate layer is defined as a “self-sealing property” of the substrate layer.

When the volume of the degassing area 5 is greater than that of the cavity of the needle N, the sample liquid having the volume corresponding to the volume difference is sucked by the degassing area 5. The self-sealing property can prevent the sample liquid discharged to the degassing area 5 from leaking out to outside of the microchip. Leaking out of the sample liquid to outside of the microchip may form a factor of interfusion (contamination) of the sample and pollution.

After the needle N is drawn out from the degassing area 5, the needle N degassed punctures the introduction part 2 to perform the injection procedure according to the procedures as described above, so that the sample liquid can be introduced into the insides of the flow channels 31 to 35 or the wells 41 to 45 without generating air bubbles.

After the sample liquid is introduced, the needle N is drawn out from the introduction part 2. Also, when the substrate layer 11 is formed of the material having elasticity such as PDMS, the punctured portion can be sealed spontaneously by resilience generated from elastic deformation of the substrate layer 11, after the needle N is drawn out.

In order to ensure the self-sealing by elastic deformation of the substrate 11, it is desirable that the needle N have a small diameter, provided that the sample liquid can be injected. Specifically, a painless needle having a tip outside diameter of about 0.2 mm used as a needle for insulin injection is desirably used. As the sample liquid holder connected to a base of the painless needle, a general-purpose micropipette chip having a cut tip can be used. Using such a configuration, the tip of the chip is filled with the sample liquid and the painless needle punctures the introduction part 2, whereby the sample liquid within the tip of the chip connected to the painless needle is sucked to the introduction part 2 by the negative pressure within the microchip 1.

When a painless needle having a tip outside diameter of 0.2 mm is used as the needle N, the substrate layer 11 formed of, for example, PDMS may desirably have a thickness of 0.5 mm or more, and 0.7 mm or more when heat is to be applied.

As stated above, in the microchip 1a according to this embodiment, after the needle N punctures the degassing area 5 to remove air within the cavity in the degassing procedure, the needle N punctures the introduction part 2 in the injection procedure, so that the sample liquid can be introduced into the insides of the flow channels 31 to 35 or the wells 41 to 45 without generating air bubbles.

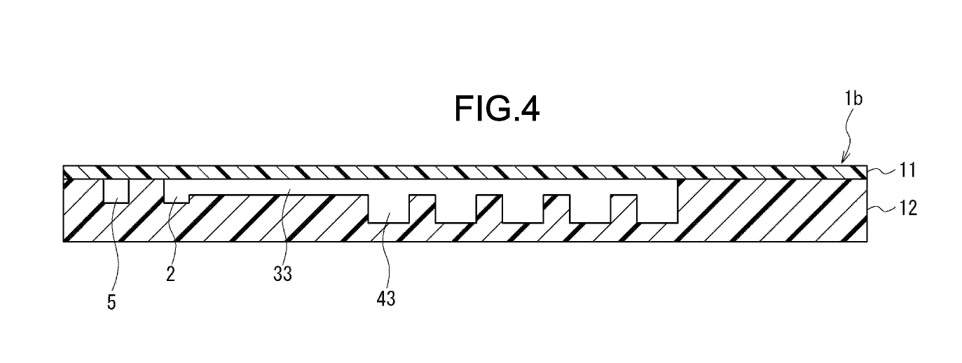

This embodiment describes the microchip 1a having a three-layered structure of the substrate layer 12 having gas non-permeability on which the introduction part 2, the flow channels 31 to 35, the wells 41 to 45 and the degassing area 5 are formed, the substrate layer 11 having the self-sealing property bonded to the substrate layer 12, and the substrate layer 13 having gas non-permeability. The substrate layer 13 is desirably bonded to the substrate layer 11 in order to maintain the introduction part 2, the flow channels 31 to 35, the wells 41 to 45 and the degassing area 5 at a reduced pressure, and to prevent leak of the sample liquid introduced into the wells 41 to 45. Alternatively, the microchip according to an embodiment of the present application may not have the substrate layer 13, and may have a two-layered structure of the substrate layers 11 and 12 such as the microchip 1b as shown in FIG. 4.

### 2. A Microchip According to a Second Embodiment

(1) A Configuration of a Microchip 1c

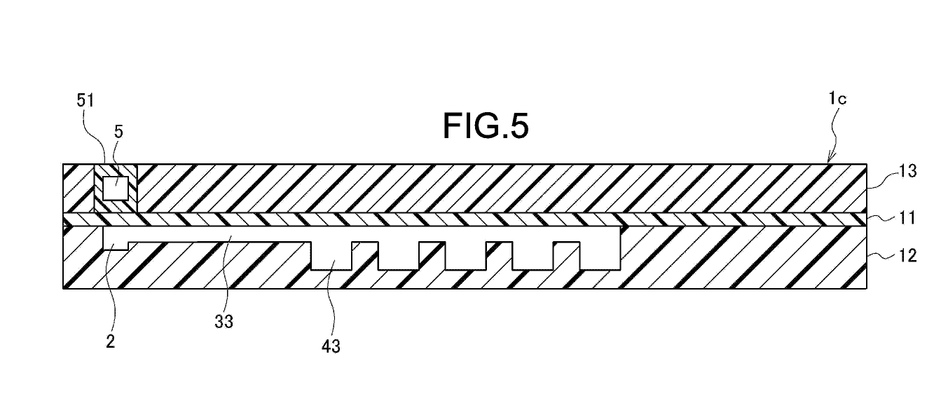

FIG. 5 is a schematic view illustrating a configuration of a microchip according to a second embodiment of the present application. The microchip 1c includes the introduction part 2, the flow channels 31 to 35, the wells 41 to 45 and the substrate layers 11 and 12 similar to those of the microchip 1a according to a first embodiment. The microchip 1c is different from the microchip 1a in that the degassing area 5 is disposed within an embedded member 51 and is embedded in the substrate layer 13.

In the microchip 1c, the degassing area 5 is disposed within the embedded member 51 as an independent area separated from the introduction part 2, the flow channels 31 to 35 and the wells 41 to 45. The embedded member 51 is composed of a member having the self-sealing property, which is specifically the material having elasticity such as PDMS similar to the substrate layer 11. The materials of the substrate layers 11, 12 and 13 are similar to those denoted by the same reference numerals of the microchip 1a.

The microchip 1c is provided by bonding the substrate layer 12 having the introduction part 2, the flow channels 31 to 35 and the wells 41 to 45 with a substrate layer 11, and embedding the embedded member 51 into the substrate layer 13 bonded to the substrate layer 11. Similar to the microchip 1a, in the microchip 1c, the substrate layer 11 is also bonded with substrate layer 12 at a pressure negative to atmospheric pressure so that the insides of the introduction part 2, the flow channels 31 to 35 and the wells 41 to 45 have a pressure negative to atmospheric pressure (desirably, vacuum) and are hermetically sealed. In addition, the inside of the embedded member 51 can have a pressure negative to atmospheric pressure by forming the member under a negative pressure. When the substrate layer 11 and the embedded member 51 are formed of the material having gas permeability in addition to the material having elasticity such as PDMS, the insides of the introduction part 2 and the embedded member 51 may be allowed to stand under a negative pressure (vacuum) to have a reduced pressure, after the substrate layers are bonded under atmosphere (normal pressure) and the members are formed.

(2) An Introduction of a Sample Liquid into the Microchip 1c

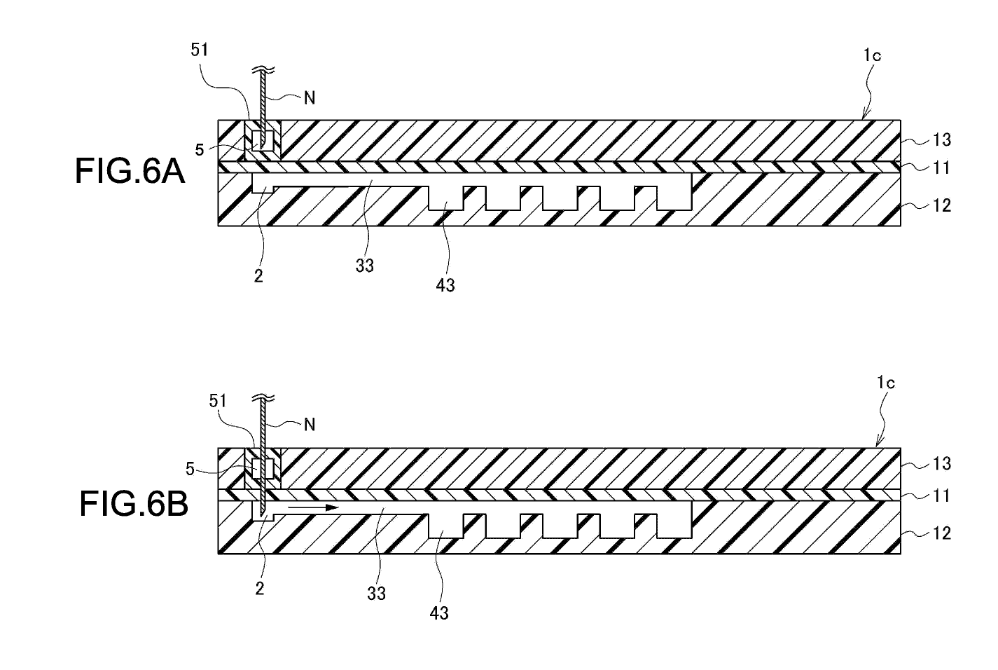

Now, referring to FIGS. 6A and 6B, the method of introducing the sample liquid into the microchip 1c will be described.

[A Degassing Procedure]

As shown in FIG. 6A, the sample solution is introduced into the microchip 1c by puncturing the embedded member 51 embedded in the position corresponding to the introduction part 2 of the substrate layer 13 using the needle N so that the tip of the needle N reaches the degassing area 5 enclosed by the embedded member 51. As the degassing area 5 has a pressure negative to atmospheric pressure, once the tip of the needle N reaches the degassing area 5, air in the cavity is sucked by the negative pressure and is discharged from the tip of the needle N together with the sample liquid sucked from the sample liquid holder connected to the other end of the needle N. Thus, the cavity of the needle N is degassed.

[An Injection Procedure]

After the cavity is degassed, the needle N punctures the substrate layer 11 through the embedded member 51 and continues to penetrate into the introduction part 2 until the tip thereof reaches the introduction part 2 through the substrate layer 11.

In the microchip 1c, as the insides of the introduction part 2, the flow channels 31 to 35 and the wells 41 to 45 have a pressure negative to atmospheric pressure, once the tip of the needle N reaches the introduction part 2, the sample liquid in a sample liquid holder is sucked by the negative pressure and is introduced into the introduction part 2. The sample liquid introduced into the introduction part 2 is further sent to the flow channels 31 to 35 and the wells 41 to 45 by the negative pressure.

After the sample liquid is introduced, the needle N is drawn out from the introduction part 2 and the embedded member 51. When the substrate layer 11 and the embedded member 51 are formed of the material having elasticity such as PDMS, the punctured portion can be sealed spontaneously by resilience generated from elastic deformation of the substrate layer 11 and the embedded member 51, after the needle N is drawn out. In the embedded member 51, a surface through which the needle N penetrates may be formed of the material having elasticity such as PDMS, and a surface through which the needle N does not penetrate may be formed of other material (such as a material having high strength).

As stated above, in the microchip 1c according to this embodiment, after the needle N punctures the degassing area 5 to remove air within the cavity in the degassing procedure, the needle N punctures the introduction part 2 in the injection procedure, so that the sample liquid can be introduced into the insides of the flow channels 31 to 35 or the wells 41 to 45 without generating air bubbles.

In the present embodiment, the microchip 1c is provided by laminating the substrate layer 11 having the self-sealing property and the substrate layer 13 having the gas non-permeability in order on the substrate layer 12 having the gas non-permeability, and embedding the embedded member 51 in the substrate layer 13. The substrate layer 13 is desirably bonded to the substrate layer 11 in order to maintain the introduction part 2, the flow channels 31 to 35, the wells 41 to 45 and the degassing area 5 at a reduced pressure, and to prevent leak of the sample liquid introduced into the wells 41 to 45. The microchip according to an embodiment of the present application may have a two-layered structure of the substrate layers 11 and 12. In such a case, the embedded member 51 will be disposed at the position corresponding to the degassing area 5 of the surface of the substrate layer 11.

### 3. A Microchip According to a Third Embodiment

(1) A Configuration of a Microchip 1d

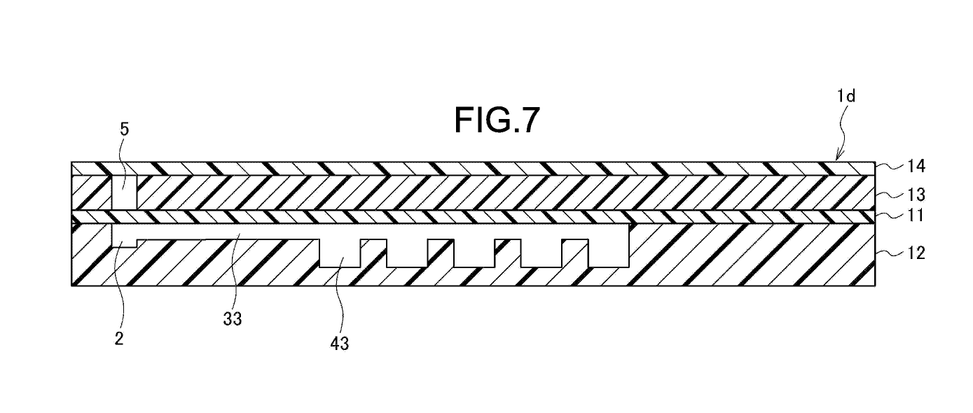

FIG. 7 is a schematic view illustrating a configuration of a microchip according to a third embodiment of the present application. The microchip 1d includes the introduction part 2, the flow channels 31 to 35, the wells 41 to 45 and the substrate layers 11, 12 and 13 similar to those of the microchip 1a according to a first embodiment. In the microchip 1d, the degassing area 5 is provided by laminating a substrate layer 14 and covering the opening for inserting to pass through the needle N disposed at the position corresponding to the introduction part 2 of the substrate layer 13 in the microchip 1a.

In the microchip 1d, the degassing area 5 is provided by bonding the substrate layers 13 and 14 as an independent area separated from the introduction part 2, the flow channels 31 to 35 and the wells 41 to 45. The substrate layer 14 is formed of the material having the self-sealing property as in the substrate layer 11. The materials of the substrate layers 11, 12 and 13 are similar to those denoted by the same reference numerals of the microchip 1a.

The microchip 1d is provided by bonding a substrate layer 12 having the introduction part 2, the flow channels 31 to 35 and the wells 41 to 45 with a substrate layer 11, and bonding the substrate layer 13 having the degassing area 5 with the substrate layer 14 in order. In the microchip 1d, the substrate layer 11 is bonded with the substrate layer 12 and the substrate layer 13 is bonded with the substrate layer 14 at a pressure negative to atmospheric pressure so that insides of the introduction part 2, the flow channels 31 to 35, the wells 41 to 45 and the degassing area 5 have a pressure negative to atmospheric pressure (desirably, vacuum) and are hermetically sealed. When the substrate layers 11 and 14 are formed of the material having gas permeability in addition to the material having elasticity such as PDMS, the introduction part 2 and the degassing area 5 may be allowed to stand under a negative pressure (vacuum) to have a reduced pressure, after the substrate layers are bonded under atmosphere (normal pressure).

(2) An Introduction of a Sample Liquid into the Microchip 1d

[A Degassing Procedure]

The sample solution is introduced into the microchip 1d by puncturing the substrate layer 14 at a position corresponding to the degassing area 5 using the needle N so that the tip of the needle N penetrates through the substrate layer 14 to reach the degassing area 5. As the degassing area 5 has a pressure negative to atmospheric pressure, once the tip of the needle N reaches the degassing area 5, air in the cavity is sucked by the negative pressure and is discharged from the tip of the needle N together with the sample liquid sucked from the sample liquid holder connected to the other end of the needle N. Thus, the cavity of the needle N is degassed.

[An Injection Procedure]

After the cavity is degassed, the needle N punctures the substrate layer 11 through the degassing area 5 and continues to penetrate into the introduction part 2 until the tip thereof reaches the introduction part 2 through the substrate layer 11.

In the microchip 1d, as the insides of the introduction part 2, the flow channels 31 to 35 and the wells 41 to 45 have a pressure negative to atmospheric pressure, once the tip of the needle N reaches the introduction part 2, the sample liquid in a sample liquid holder is sucked by the negative pressure and is introduced into the introduction part 2. The sample liquid introduced into the introduction part 2 is further sent to the flow channels 31 to 35 and the wells 41 to 45 by the negative pressure.

After the sample liquid is introduced, the needle N is drawn out from the introduction part 2 and the degassing area 5. When the substrate layers 11 and 14 are formed of the material having elasticity such as PDMS, the punctured portion can be sealed spontaneously by resilience generated from elastic deformation of the substrate layers 11 and 14, after the needle N is drawn out.

As stated above, in the microchip 1d according to this embodiment, after the needle N punctures the degassing area 5 to remove air within the cavity in the degassing procedure, the needle N punctures the introduction part 2 in the injection procedure, so that the sample liquid can be introduced into the insides of the flow channels 31 to 35 or the wells 41 to 45 without generating air bubbles.

### 4. A Microchip According to a Fourth Embodiment

(1) A Configuration of a Microchip 1e

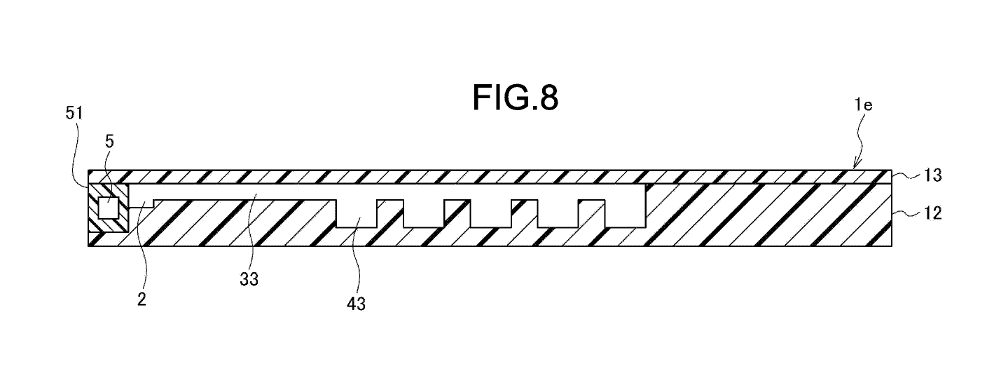

FIG. 8 is a schematic view illustrating a configuration of a microchip according to a fourth embodiment of the present application. The microchip 1e includes the introduction part 2, the flow channels 31 to 35 and the wells 41 to 45 similar to those of the microchip 1a according to a first embodiment. The microchip 1e is characterized in that the degassing area 5 is enclosed by embedded member 51 and is embedded between the substrate layers 12 and 13 which are bonded.

In the microchip 1e, the degassing area 5 is enclosed by the embedded member 51 as an independent area separated from the introduction part 2, the flow channels 31 to 35 and the wells 41 to 45. The embedded member 51 is formed of the material having the self-sealing property, specifically of the material having elasticity such as PDMS as in the substrate layer 11. The materials of the substrate layers 12 and 13 are similar to those denoted by the same reference numerals of the microchip 1a.

The microchip 1e is provided by inserting the embedded member 51 between the substrate layer 12 having the introduction part 2, the flow channels 31 to 35 and the wells 41 to 45 and the substrate layer 13, and bonding the substrate layers. In the microchip 1e, the substrate layer 12 is bonded with the substrate layer 13 at a pressure negative to atmospheric pressure so that insides of the introduction part 2, the flow channels 31 to 35 and the wells 41 to 45 have a pressure negative to atmospheric pressure (desirably, vacuum) and are hermetically sealed. Also, when the embedded member 51 is formed under a negative pressure, the inside thereof can have a pressure negative to atmospheric pressure. When the embedded member 51 is formed of the material having gas permeability in addition to the material having elasticity such as PDMS, the introduction part 2 and others, as well as the embedded member 51, may be allowed to stand under a negative pressure (vacuum) to have a reduced pressure, after the member is formed under atmosphere (normal pressure).

(2) An Introduction of a Sample Liquid into the Microchip 1e

[A Degassing Procedure]

The sample solution is introduced into the microchip 1e by puncturing the embedded member 51 embedded in the position corresponding to the introduction part 2 between the substrate layer 12 and the substrate layer 13 using the needle N so that the tip of the needle N reaches the degassing area 5 enclosed by the embedded member 51. As the degassing area 5 has a pressure negative to atmospheric pressure, once the tip of the needle N reaches the degassing area 5, air in the cavity is sucked by the negative pressure and is discharged from the tip of the needle N together with the sample liquid sucked from the sample liquid holder connected to the other end of the needle N. Thus, the cavity of the needle N is degassed.

[An Injection Procedure]

After the cavity is degassed, the needle N penetrates into the embedded member 51 until the tip thereof reaches the introduction part 2 adjacent the embedded member 51.

In the microchip 1e, as the insides of the introduction part 2, the flow channels 31 to 35 and the wells 41 to 45 have a pressure negative to atmospheric pressure, once the tip of the needle N reaches the introduction part 2, the sample liquid in a sample liquid holder is sucked by the negative pressure and is introduced into the introduction part 2. The sample liquid introduced into the introduction part 2 is further sent to the flow channels 31 to 35 and the wells 41 to 45 by the negative pressure.

After the sample liquid is introduced, the needle N is drawn out from the introduction part 2 and the embedded member 51. When the embedded member 51 is formed of the material having elasticity such as PDMS, the punctured portion can be sealed spontaneously by resilience generated from elastic deformation of the embedded member 51, after the needle N is drawn out.

As stated above, in the microchip 1e according to this embodiment, after the needle N punctures the degassing area 5 to remove air within the cavity in the degassing procedure, the needle N punctures the introduction part 2 in the injection procedure, so that the sample liquid can be introduced into the insides of the flow channels 31 to 35 or the wells 41 to 45 without generating air bubbles.

In each embodiment as described above, the shape, the position and the number of the flow channel, the well and the degassing area can be arbitrary and are not especially limited. Also in each embodiment, a well is described as an area that becomes an analysis site of a substance or a reaction product of the substance contained in the sample liquid. The area may have any shape such as the flow channel.

The present disclosure may have the following configurations.

(1) A microchip, including independently:

an introduction area inside having a pressure negative to atmospheric pressure and into which a liquid is injected by puncturing; and

a degassing area inside having a pressure negative to atmospheric pressure and where a hollow tube, which punctures the introduction area for injecting the liquid, punctures for degassing a cavity of the hollow tube.

(2) The microchip according to (1), in which

the introduction area and the degassing area are disposed such that the hollow tube punctures and passes through the degassing area and further punctures the introduction area.

(3) The microchip according to (1) or (2), in which

the degassing area is configured to include a substrate layer having a self-sealing property caused by elastic deformation.

(4) The microchip according to any one of (1) to (3), in which

the degassing area includes a substrate layer having a self-sealing property caused by elastic deformation constituting the introduction area, and a substrate layer having gas non-permeability laminated on the substrate layer having the self-sealing property.

(5) The microchip according to (1) or (2), in which

the degassing area is configured by a member having a self-sealing property caused by elastic deformation,

the member is disposed on or embedded into a surface of the substrate layer forming the microchip.

(6) The microchip according to (5), in which

the member is embedded into the substrate layer having gas non-permeability laminated on the substrate layer having the self-sealing property caused by elastic deformation and constituting the introduction area.

(7) A microchip, including:

at least one area inside having a pressure negative to atmospheric pressure which is disposed as an independent area separated from an introduction area into which a liquid is injected by puncturing.

According to an embodiment of the present application, there is provided a microchip that can introduce a sample solution into a well or a flow channel in a short time easily without generating air bubbles, thereby performing highly accurate and efficient analysis. Consequently, the microchip of an embodiment of the present application can be favorably used as an electrophoresis apparatus that separates a plurality of substances in microchips by electrophoresis, and optically detects substances separated, a reaction apparatus (for example, a nucleic acid amplification apparatus) that proceeds reactions of a plurality of substances in wells on microchips, and optically detects substances produced, or the like.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A microchip, comprising independently:
an introduction area inside having a pressure negative to atmospheric pressure and into which a liquid is injected by puncturing; and
a degassing area inside having a pressure negative to atmospheric pressure and where a hollow tube, which punctures the introduction area for injecting the liquid, punctures for degassing a cavity of the hollow tube.

2. The microchip according to claim 1, wherein
the introduction area and the degassing area are disposed such that the hollow tube punctures and passes through the degassing area and further punctures the introduction area.

3. The microchip according to claim 2, wherein
the degassing area is configured to include a substrate layer having a self-sealing property caused by elastic deformation.

4. The microchip according to claim 3, wherein
the degassing area includes a substrate layer having a self-sealing property caused by elastic deformation constituting the introduction area, and a substrate layer having gas non-permeability laminated on the substrate layer having the self-sealing property.

5. The microchip according to claim 2, wherein
the degassing area is configured by a member having a self-sealing property caused by elastic deformation,
the member is disposed on or embedded into a surface of the substrate layer forming the microchip.

6. The microchip according to claim 5, wherein
the member is embedded into the substrate layer having gas non-permeability laminated on the substrate layer having the self-sealing property caused by elastic deformation and constituting the introduction area.

7. A microchip, comprising:
at least one area inside having a pressure negative to atmospheric pressure which is disposed as an independent area separated from an introduction area into which a liquid is injected by puncturing.
